(19) United States
(12) Patent Application Publication
(10) Pub. No.: US 2004/0102858 A1
(43) Pub. Date: May 27, 2004

(54) Soft-touch gripping mechanism for flat objects

(76) Inventors: Boris Kesil, San Jose, CA (US); Elik Gershenzon, Daly City, CA (US)

Correspondence Address: MultiMetrixs LLC, Attn: Boris Kesil, 1040 Di Giulio Avenue, #200, Santa Clara, CA, 95050, US

(21) Appl. No.: 10/719,411

(22) Filed: Nov. 24, 2003

Related U.S. Application Data
(63) Continuation-in-part of application No. 09/944,605, filed on Sep. 4, 2001.

(51) Int. Cl. G05B 11/01

(52) U.S. Cl. 700/11

(57) ABSTRACT

A soft-touch gripping mechanism of the invention contains three gripping fingers arranged circumferentially around a circular flat object such as, e.g., a semiconductor wafer. The soft-tough force applied to the wafer from the gripping posts on the ends of the gripping fingers is controlled from a common force measurement sensor, e.g., a special position sensor that consists of a moveable magnetic flag attached to a pusher plate on the end of the output shaft of a linear stepper motor and a sensitive member, e.g. a Hall sensor chip that responds to the position of the magnetic flag. The Hall sensor produces an output voltage signal that is proportion to the position of the flag relative to the Hall sensor chip. The sensor is connected to a controller that also controls operation of the aforementioned linear stepper motor. The soft touch is achieved by transmitting the movement of the pusher to the linear fingers through a spring. In order to facilitate insertion of the distal finger into narrow slots between the flat objects, such as semiconductor wafers in the storage cassette, the distal post can be turned by an angle less 90°. Reduced rotary sliding movement minimizes a chance of contamination of the wafer with products of wear.

### CROSS-REFERENCE TO RELATED APPLICATIONS

The present patent application is a continuation in part of U.S. patent application Ser. No. 09/944,605 filed on Jun. 9, 2001 and entitled “Precision Soft-Touch Gripping Mechanism for Flat Objects”.

### FIELD OF THE INVENTION

The present invention relates to the field of material handling equipment, in particular to mechanisms used in semiconductor production, disk-drive manufacturing industry and the like for precision gripping, transportation and positioning delicate, thin and highly accurate flat objects such as semiconductor wafers, hard disks, etc. In particular, the invention relates to a soft-touch gripping mechanism for transferring semiconductor wafers between a FOUP of wafer storage cassette and a wafer processing station, or the like. The mechanism of the invention may be especially useful for extracting semiconductor wafers from or loading semiconductor wafers into storage cassettes with narrow spaces between parallelly stacked wafers stored in the cassette.

### BACKGROUND OF THE INVENTION

One of the major methods used at the present time in the semiconductor industry for grasping, holding, moving, and positioning of semiconductor wafers is the use of a mechanical hand of a robot equipped with a vacuum chuck.

From the beginnings of the semiconductor industry to the late 1980s, wafers were handled manually and later by rubber-band conveyors and cassette elevators. The first standards for wafer of 2″, 4″, 6″ diameters and appropriate cassette dimensions allowed to develop simple wafer handling mechanisms and standardize their designs. The early forms of automated handling contributed to improved yields by reducing wafer breakage and particle contamination. A variety of equipment layouts were used, but the general conception remained the same. In other words, the automation systems of that time relied mostly on stepper-motor-driven conveyor belts and cassette elevators to eliminate manual handling.

A central track would shuttle wafers between elevator stations that serviced cassettes and “tee” stations that serviced the process stations. This to some extent helped to reduce breakage, but did not solve the contamination problem. Furthermore, most equipment had manual loading as the standard, with the conveyor and elevators added. These systems were reliable and cheap and served as a good prerogative to automation of wafer handling by the times when 200-mm wafers came into use.

Further progress of the industry accompanied by an increase in the diameter of wafer with 200-mm diameter as a standard for substrates led to drastic changes in principles wafer handling occurred. Driven by ever-decreasing linewidths, tighter cleanliness and throughput requirements, and improvements in robotic technology, the rubber-band conveyor/cassette elevator solution was surpassed by true robotic wafer handling.

The new robotics consisted of polar-coordinate robot arms moving wafers with so-called “vacuum end effectors”. In robotic, the end effector is a device or tool connected to the end of a robot arm. For handling semiconductor wafers, an end effector may be made in the form of grippers of the types described, e.g., in U.S. Pat. No. 5,108,140, U.S. Pat. No. 6,116,848, and U.S. Pat. No. 6,256,555. More detailed description of these end effectors or grippers will be considered later.

These robots were an improvement over the earlier technology. Since the robot's movements were controlled by microprocessor-based servo controllers and servomotors, it became possible to greatly improve the throughput, reliability, and error handling of the wafer handling systems. For example, a typical rubber-band conveyor and cassette elevator system could handle only tens of wafers per hour, while a three-axis robot could move hundreds. Reliability for robots was increased at least up to 80,000 hours mean time between failures (MTBF) compared to a few thousand hours for the conveyor systems. In the case of an emergency, the operator must immediately locate a wafer. This was not always possible with a belt-drive conveyor that could not always determine a current position of the wafer, whereas a robot system, which was characterized by a few possible wafer locations, could significantly facilitate a solution of the problem and allowed automated error handling.

Introduction of microprocessor control allowed true unattended equipment operation. Operators could manually load cassettes, and the tool could automatically process full wafer lots. Standards also were improved and introduced into use (see, e.g., SEMI standards). However, these standards helped reduce, but did not eliminate, the confusion involved in the selection and application of robotic wafer handling. For example, there are SEMI standards for cassettes, yet many nonstandard cassettes are used. Another compromise is the need to design semiconductor-manufacturing equipment suitable for accepting a large variety of wafer sizes. This adds unnecessary complexity to equipment design.

Furthermore, many equipment manufacturers built their own robots. Each model had to be adaptable to many different wafer sizes and a variety of cassettes.

Recent transfer to 300-mm wafers, evolved new problems associated with much higher final cost of a single wafer (up to several thousand dollars as compared with several hundred dollars for 200 mm wafers) and thus required higher accuracy and reliability of the wafer handling equipment. These problems become even more aggravated for handling double-sided polished wafers, where both sides of the wafer are used for the production of the chip. A specific feature of end effectors intended for handling double-sided polished wafers is that they can touch the wafers only at their edges.

Furthermore, transition to 300 mm wafers made the use of low vacuum unsuitable for holding and handling the wafers. The main reason that in order to protect the wafer from contamination through the mechanical contact with holding parts of the robot arm, both sides (front or back) of the wafer become untouchable for handling. Another reason is that vacuum holders are not reliable for handling wafers of heavy weight. Thus, the conventional vacuum end effectors appeared to be unsuitable for handling expensive, heavy, and hard-to-grip wafers of 300 mm diameter.

According to Semi Standards, the allowance for the gripping area of the 300 mm wafer should not exceed 3 mm from the edge of the wafer and preferably to be down to 1.5 mm or even less. To reliably hold the wafer and to protect it from breaking during all handling transportation procedures, it is necessary to use a limited holding force of at least at 3 points circumferentially spaced along the edge of the wafer.

Since the position of each cassette and each wafer within the cassette is unique, the location of each wafer within the three planes of the orthogonal coordinate system relative to the reference plane of robot arm should be measured and used for precise positioning of the robot arm that carries the gripper. Using mechanical measurements or preliminary mapping procedures of location of the wafer in a cassette for precise positioning of the gripper relatively to the grasping points is a time consuming procedure that is difficult to perform in real conditions of the variety of wafer stages at wafer handling robotic lines.

U.S. Pat. No. 5,570,920 issued on Nov. 5, 1996 to J. Crisman et al. describes a robot arm with a multi-fingered hand effector where the fingers are driven from a DC motor via a system of pulleys with control of a grasping force by means of strain gauges attached to the inner surfaces of the fingers. However, such a robot arm is three-dimensional and is not applicable for handling thin flat objects, such as semiconductor wafers, located in a deep narrow slots of a multistack cassette of the type used for storing the wafers.

U.S. Pat. No. 6,167,322 issued on Dec. 26, 2000 to O. Holbrooks, which describes intelligent wafer handling system, is typical of the state of the art in two aspects. Holbrooks system removes wafers from the cassette using a gripper that can slip in between parallelly stacked and spaced wafers that has one or more actuating rods and one or more rotating fingers which are rotated by 90 degrees. Translator solenoid acting through an arm applies lateral movement to the finger to grasp the wafer between the finger and the posts. Grasping action is accomplished by using the finger to pressure the wafer against the fixed rods. The level of the pressure is maintained through the control of the electrical current applied to the driving translator. Hollbrook claims that the system can locate the position of the wafer with high degree of accuracy by employing light beams and photo sensors. The intelligent wafer handling system consists of a wafer-mapping sensor mounted on the wrist end of the hand. The optics of the sensor is comprised of optical transmitters such as lasers or IR diodes and optical receivers such as CCD's or phototransistors used to receive reflections from the edge of the wafer. To determine the position of the front edge of the wafer, Hollbrook recommended using laser distance measuring unit. A laser head located on a two-axis mount would sweep the column of wafers in the cassette. To avoid the misreading of the wafer position, the sensor should span the small focal point across the edge. Hoolbrook recommended to avoid bending or cracking a wafer by lifting the movable finger, controlled precisely by closely controlling current through the voice coil of actuator.

A disadvantage of the wafer handling system of Holbrooks consists in that this apparatus does not provide control of gripping speed at different stages of the gripping cycle. Another disadvantage of the Holbrooks system consists in that this system does not provide decrease in gripping pressure when the gripper approaches the edge of the wafer with acceleration.

U.S. Pat. No. 6,256,555 issued to Paul Bacchi, Paul S. Filipski on Jul. 3, 2001 shows gripping end effectors for wafers of more then 6 inches in diameter that include proximal and distal rest pads having pad and backstop portions that support and grip the wafer within the annular exclusion zone. The end effector includes a fiber optic light-transmitting sensor for the wafer periphery and bottom surface. A disadvantage of the device of U.S. Pat. No. 6,256,555 consists in that this device does not allow to divide the gripping process into several stages with different controllable speeds. In order to prevent jerks at the moment of contact of the gripper with the wafer edge, the last stage of movement of the gripping fingers should be carried out with a reduced speed. The decrease in speed, however, reduces productivity of the gripper's operation. This problem is solved neither by the device of U.S. Pat. No. 6,256,555 nor by any of the previously described devices.

An attempt to solve the aforementioned problems of the prior art was made in U.S. patent application Ser. No. 09/944,605 filed in 2001 by B. Kesil, et al. The precision soft-touch gripping mechanism disclosed in that application has a mounting plate attached to a robot arm. The plate supports a stepper motor. The output shaft of the stepper motor is connected through a spring to an elongated finger that slides in a central longitudinal slot of the plate and supports a first wafer gripping post, while on the end opposite to the first wafer gripping post the mounting plate pivotally supports two L-shaped fingers with a second and third wafer gripping posts on their respective ends. The mounting plate in combination with the first sliding finger and two pivotal fingers forms the end effector of the robot arm, which is thin enough for insertion into a wafer-holding slot of a wafer cassette. The end effector is equipped with a mapping sensor for detecting the presence or absence of the preceding wafer, wafer position sensors for determining positions of the wafer with respect to the end effector, and force sensors for controlling the wafer gripping force. Several embodiments relate to different arrangements of gripping rollers and mechanisms for control of the gripping force and speed of gripping required for gripping the wafer with a soft and reliable touch.

A specific feature of the mechanism of U.S. patent application Ser. No. 09/944,605 that advantageously distinguishes it from the Holbrooks system, which technically is the nearest one to the mechanism of the aforementioned patent application, is that the proposed mechanism for the first time suggests the use of three moveable fingers with gripping posts at the ends of the fingers that are arranged circumferentially around the periphery of the wafer and that have an independent soft touch at each post.

A schematic top view of the mechanism of U.S. patent application Ser. No. 09/944,605 that illustrates kinematics of the mechanism is shown in FIG. 1.

It can be seen from FIG. 1 that the grasping mechanism or end effector, which in general is designated by reference numeral 20, consists of three linking members or gripping fingers. A first linking member or gripping finger 22 is made in the form of a longitudinal bar. The movements and connections of the first linking member or finger 22 will be described in more detail later. The distal end of the first finger or bar 22 supports a first or distal post 24.

A second linking member or gripping finger 26 and a third linking member or gripping finger 28 comprise levers of the second order made in the form of substantially angular arms which are pivotally installed on axles 29 and 31 attached to a flat gripper body 33. The proximal end of the bar 22 is the one opposite to the above-mentioned distal end that supports the distal post 24.

Free ends of fingers or arms 26 and 28 support the second and third posts 36 and 38 for gripping the peripheral edges of the wafer W. A plate 30 is rigidly connected to the bar 22 and to an actuating rod 40 of a linear precision drive mechanism 42, e.g., a stepper motor. The stepper motor 42 is attached to a stationary member, e.g., the gripper body 33.

The end of the gripping finger 26 opposite to the post 36 has a longitudinal slot 26a, and the end of the gripping finger 28 opposite to the post 38 has a longitudinal slot 28a. The parts of the slots 26a and 28a are overlapped, and a pin 32 that is rigidly attached to the gripper finger 22 is slidingly guided in both slots 26a and 28a.

As a result, when the actuator rod 40 of the stepper motor 42 moves the plate 30 in the direction of arrows A (FIG. 1), the provision of the pin 32 in the slots 26a and 28a and stationary pivotal axles 29 and 31 will cause the gripper fingers 26 and 28 to turn around the axles 29 and 31 and to move them toward each other or away from each other (depending on the direction of the arrows A) and hence to move the posts 36 and 38 toward the edge E of the wafer W (the positions shown in FIG. 1 by solid lines) or away from the wafer (the positions shown in FIG. 1 by a broken lines).

In the mechanism 20 shown in FIG. 1, the principle of soft touch is based on independent touch control of the post 24, 36, and 38, which are spring-loaded with respective springs 24a, 36a, and 38a. The springs are provided with respective strain gages 34b, 36b, and 38b. All three individual strain gages are connected to a common control unit 50. In this system, soft touch may be achieved by programming the control unit 50 for stopping movement of the posts 24, 36, and 38 towards the edge of the wafer W from the stepper motor 42 when predetermined output signals are obtained from the sensors. Operation of the stepper motor 42 is also controlled from the control unit 50. The control unit 50 may comprise a separate unit or can be built into the gripper body 33.

In spite of the fact that the above-described mechanism of U.S. patent application Ser. No. 09/944,605 provides efficient soft touch with the use of three independently moveable gripping fingers, this mechanism has individual control of all three gripping fingers via the control unit 50, which is sufficiently complicated and expensive.

Experiments showed that mechanism of U.S. patent application Ser. No. 09/944,605 has the lowest level of contamination (which is extremely important for satisfying the clean-room requirements). This is achieved due to the fact that all sliding pairs are isolated from the zone where wafers are located and due to the fact that the distal post 24 is stationary. However, a disadvantage of the stationary post 24, which has a predetermined height, is that, in order to prevent interference between the post 24 and the wafer, the mechanism requires the use of complicated wafer position detecting sensors.

The last-mentioned drawback is solved in the aforementioned Holbrooks system that utilizes a rotatable distal pin, which is turned by 90° for orientation in the plane parallel to the surface of the wafer when the pin is inserted into the slot of the wafer storage cassette. In fact, due to the presence of the notch on the edge of the wafer, in order to prevent interference of the post with the notch, the mechanism should have at least two distal posts. This means that the members of the mechanism located in the zone of wafers have two rotary sliding pairs that are turned at least by 90° and may cause contamination of the wafer with the product of wear.

Thus, the authors are not aware of any existing soft-touch gripping mechanism for loading/unloading flat precision objects that simultaneously satisfies the requirements of simplicity, reliability of soft touch and non-contamination of the objects during handling under strict clean-room requirements.

### OBJECTS AND SUMMARY OF THE INVENTION

It is an object of the invention to provide an improved soft-touch gripping apparatus for loading/unloading flat precision objects under strict clean-room requirements that simultaneously satisfies the requirements of simplicity, reliability of soft touch and non-contamination of the objects during handling. Another object is to provide the soft-touch gripping mechanism with a device for precision adjustment of the gripping force.

The soft-touch gripping mechanism is essentially similar to the above-described mechanism of U.S. patent application Ser. No. 09/944,605 in that it contains three gripping fingers arranged circumferentially around a circular flat object such as, e.g., a semiconductor wafer. However, in contrast to the previous design, the gripping mechanism of the invention is significantly simplified by controlling the object-touch force with the use of a single touch-force sensor associated with a single linearly moveable pin, which is common for all three gripping fingers. This pin is rigidly connected to a first gripping finger that supports a distal gripping post and slides in the slots formed on the ends of two other V-shaped symmetrical side fingers, which can rotate on stationary axes relative to the periphery of the object. The ends of the fingers that contain the slots are opposite to the ends that support the gripping posts.

The aforementioned common pin is connected to a frame that slides in the axial direction of the first gripping finger and is rigidly connected thereto. The gripper body also supports a linear stepper motor, the output shaft of which is inserted into the aforementioned frame and is coaxial with the first gripping finger. The free end of the motor output shaft supports a pusher plate, which is pressed against the frame by a compression spring located between the pusher plate and the end face of the frame opposite to the object. When the stepper motor is activated, its output shaft with the pusher plate moves linearly towards (forward movement) or away (retraction movement) from the object whereby the spring is decompressed or compressed. When, in the forward movement the pusher plate meets the end face of the frame nearest to the object, further movement of the output shaft is continued together with the frame and, hence, with the aforementioned common pin located in the slots on the ends of the side gripping fingers. As a result, the side gripping fingers rotate on their pivot axes so that the gripping posts on the opposite ends of these fingers are moved away from the edge of the object, e.g., semiconductor wafer, for expanding the space into which an object can be place or from which the object can be removed, e.g., by a mechanical arm of a robot. Meanwhile, the distal gripping post that is attached to the distal end of the first finger also participates in the outward movement from the object since the first finger is rigidly connected to the aforementioned common pin.

For gripping the object with a soft touch, the linear stepper motor is reversed, the pusher plate begins to move away from the object and compresses the spring, whereby a reversing axial force of the pusher plate is transmitted via the spring to the frame. The frame commences its movement away from the object together with the common pin. The latter slides in the slots of the side gripping fingers and at the same time turns these fingers so that their respective gripping posts are moved towards the edge of the object. The distal post also moves inwardly towards the object.

When all three gripping posts spring-loaded by a common spring come into soft-touch contact with the edge of the object, the movement of the frame is decelerated. The touch-force is precisely measured and controlled with the use of a special position sensor that consists of a moveable magnetic flag attached to the side of the aforementioned pusher plate and a sensitive member, e.g. a Hall sensor chip that responds to the position of the magnetic flag. The Hall sensor produces an output voltage signal that is proportion to the position of the flag relative to the Hall sensor chip. It is understood that the output signal of the Hall sensor can be used for controlling the driver of the stepper motor and thus for controlling the final soft-touch gripping force. The final soft-touch gripping force corresponds to a predetermined value of an output signal of the Hall sensor. When this value reaches the one set in the controller, the latter sends a stopping command to the stepper-motor driver.

In order to facilitate insertion of the distal finger into narrow slots between the flat objects, such as semiconductor wafers in the storage cassette, the distal post can be turned as in the aforementioned Holbrooks patent. However, in order to improve the non-contamination conditions over the Holbrooks device, the first finger with the distal post is rotated by less than 75°.

### BRIEF DESCRIPTION OF THE DRAWINGS

FIG. 1 is a three-dimensional view illustrating kinematics of a known wafer gripping mechanism.

FIG. 2 is a three-dimensional schematic view of the wafer gripping mechanism of the invention with gripping fingers in open (expanded) positions.

FIG. 3 is a three-dimensional schematic view of the wafer gripping mechanism of FIG. 2 with gripping fingers in closed (gripping) positions.

FIG. 4 is a schematic view of the gripping mechanism of the invention which, in general, is the same as the mechanism shown in FIGS. 2 and 3, but with an addition of a mechanism for rotating the distal gripping post.

FIG. 5A is a fragmental end view of the distal gripping post arrangement in the direction of arrow C of FIG. 4 with the distal gripping post shown in a hidden position for insertion into a narrow space between the adjacent wafers in the storage cassette.

FIG. 5B is a fragmental side view of the distal gripping post in the gripping position.

FIG. 6 is a general three-dimensional view of the soft-touch gripping mechanism of the third embodiment shown with the upper cover removed for simplicity of the explanation.

FIG. 7 is a fragmental end view in the direction arrow K of FIG. 6.

FIG. 8 is a view similar to FIG. 7 but with the distal finger posts turned by an angle less than 90° to the wafer gripping position.

FIG. 9 is a view similar to FIG. 3 for embodiment of the invention with a contact sensor attached to a pusher plate stopper, the grippers being shown in a closed position.

FIG. 10 is a view similar to FIG. 2 for embodiment of the invention with a contact sensor attached to a pusher plate stopper, the grippers being shown in an open position.

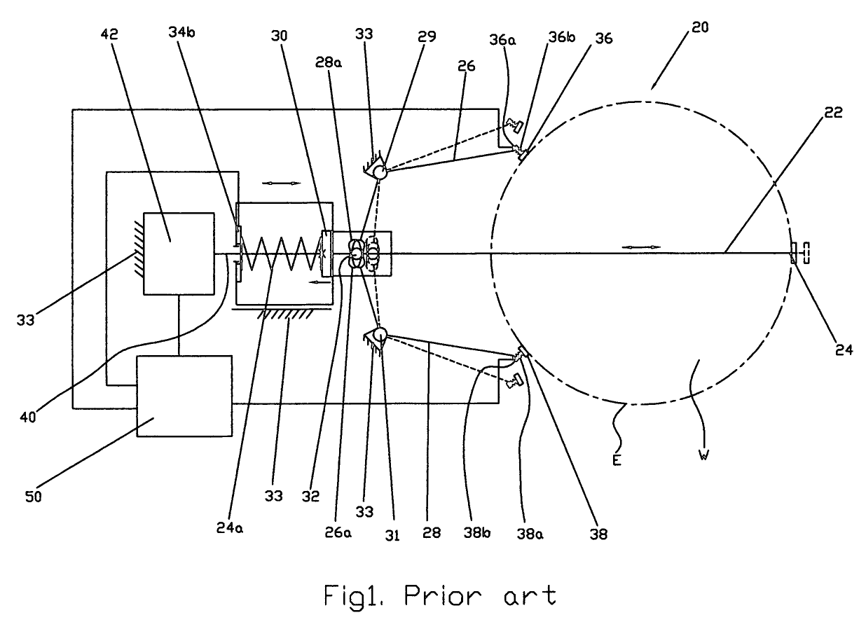

### DETAILED DESCRIPTION OF THE INVENTION

The soft-touch gripping mechanism of the invention, which as a whole is designated by reference numeral 120, is essentially similar to the above-described mechanism of U.S. patent application Ser. No. 09/944,605. In other words, the mechanism 120 contains three gripping fingers, i.e., a first gripping finger 122 which is made in the form a longitudinal bar and supports on its free end a distal gripping post 124, a second side gripping finger 126 of a V-shaped configuration with a gripping post 136, and a third side gripping finger 128 of a V-shaped configuration with a gripping post 138. In fact, the second side gripping finger 126 and the third side gripping finger comprise levers of the second order which are arranged symmetrically relative to the first gripping finger 122. The gripping posts 124, 136, and 138 are arranged circumferentially around a circular flat object such as, e.g., a semiconductor wafer W. However, in contrast to the previous design, the gripping mechanism 120 of the invention is significantly simplified by controlling the object-touch forces between the gripping posts 124, 136, and 138 and the edge E of the semiconductor wafer W with the use of a single touch-force sensor S (described in detail below) associated with a single linearly moveable pin 132, which is common for all three gripping fingers 122, 126, and 128.

The pin 132 is rigidly connected to the first gripping finger 122 and slides in the slots 126a and 128a formed on the ends of two other V-shaped fingers 126 and 128 which can rotate on stationary axes 129 and 131 relative to the periphery of the semiconductor wafer W. The ends of the rotating fingers that contain the slots 126a and 128a are opposite to the ends that support the gripping posts 136 and 138.

The aforementioned common pin 132 is connected to a frame F that slides in stationary guides (not shown) of a flat gripper body 133 in the axial direction X-X of the first gripping finger 122 and is rigidly connected to the first gripping finger 122. The gripper body 133 also supports a linear stepper motor 142 with a driver. The output shaft 140 of the motor 142 is inserted into the aforementioned frame F. The output shaft of the stepper motor 142 performs linear motions in the axial direction X-X towards or away from the semiconductor wafer W and will be hereinafter referred to as a plunger 140. The free end of the plunger 140 supports a pusher plate 130, which is pressed against the frame F by a compression spring 124a located between the pusher plate 130 and the end face 121 of the frame F opposite to the semiconductor wafer W.

Reference numeral 150 designates a controller that is connected to the driver of the linear stepper motor 142 and with other actuating units of the mechanisms which will be described later.

When the stepper motor 142 moves the plunger 140 with the pusher plate 130 linearly towards the semiconductor wafer W (in the direction of arrow A towards the wafer) or away from the semiconductor wafer W (in the direction of arrow A away from the wafer W), the spring 124a is decompressed or compressed. When, in the course of the forward movement the pusher plate 130 comes into contact with the end face 123 of the frame F nearest to the semiconductor wafer W, the further movement of the plunger 140 is continued together with the frame F (in the direction of arrow B) and, hence, with the aforementioned common pin 132 located in the slots 126a and 128a on the ends of the side gripping fingers 126 and 128. As a result, the side gripping fingers 126 and 128 rotate on their pivot axes 129 and 131 so that the gripping posts 136 and 138 on the opposite ends of these fingers are moved away from the edge E of the semiconductor wafer W for expanding the space into which the wafer W can be placed or from which the wafer W can be removed, e.g., by a mechanical arm of a robot (not shown). Meanwhile, the distal gripping post 124 that is attached to the distal end of the first finger 122 also participates in the outward movement from the wafer W since the first finger 122 is rigidly connected to the aforementioned common pin 132.

For gripping the wafer W with soft touch, the linear stepper motor 142 is reversed, the pusher plate 130 begins to move away from the wafer W and compresses the spring 124a, whereby a reversing axial force of the pusher plate 130 is transmitted via the spring 124a to the frame F. The frame F commences its movement away from the wafer W together with the common pin 132. The latter slides in the slots 126a and 128a of the side gripping fingers 126 and 128 and at the same time turns these fingers 126 and 128 so that their respective gripping posts 136 and 138 are moved towards the edge E of the wafer W. The distal post 124 also moves inwardly towards the edge E of the wafer W.

When all three gripping posts 124, 136, and 138 spring-loaded by a common spring 124a come into soft-touch contact with the edge E of the wafer W, the movement of the frame F is decelerated.

The touch-force is precisely measured and controlled with the use of a special position sensor S. The sensor S may comprise, e.g., a magnetic sensor (Hall sensor) that consists of a moveable magnetic flag 152 attached to the side of the aforementioned pusher plate 130 and a sensitive member, e.g. a Hall sensor chip 151 that responds to the position of the magnetic flag 152. The Hall sensor S produces an output voltage signal that is proportion to the position of the flag 152 relative to the Hall sensor chip 151. It is understood that an output signal of the Hall sensor S can be used for controlling the driver of the stepper motor 142 and thus for controlling the final soft-touch gripping force. The final soft-touch gripping force corresponds to a predetermined value of an output signal of the Hall sensor S. When this value reaches the one set in the controller 150, the latter sends a stopping command to the driver of the stepper-motor 142. Thus the final soft-touch gripping force of the gripping posts 124, 136, and 138 relative to the edge E of the semiconductor wafer W can be adjusted by setting the controller 150 to a required value.

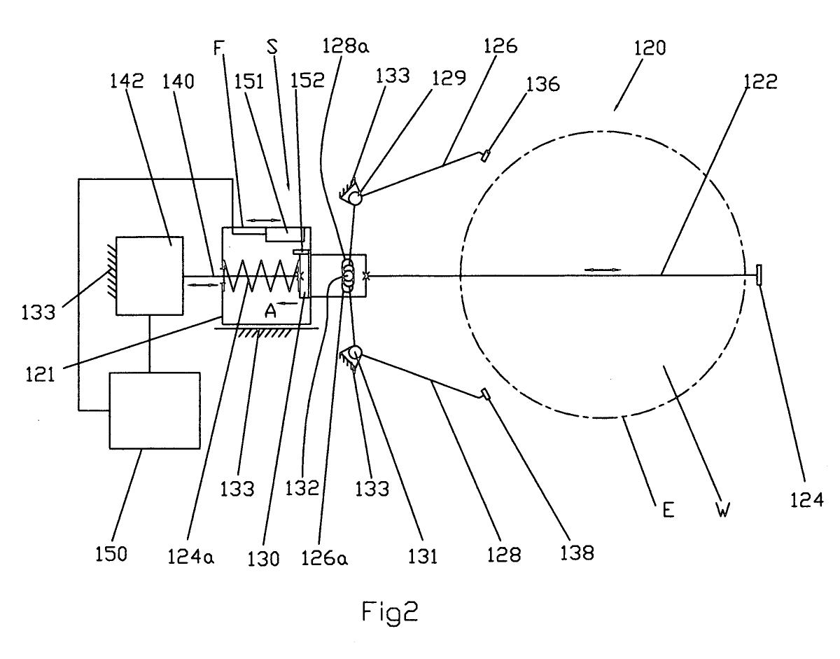

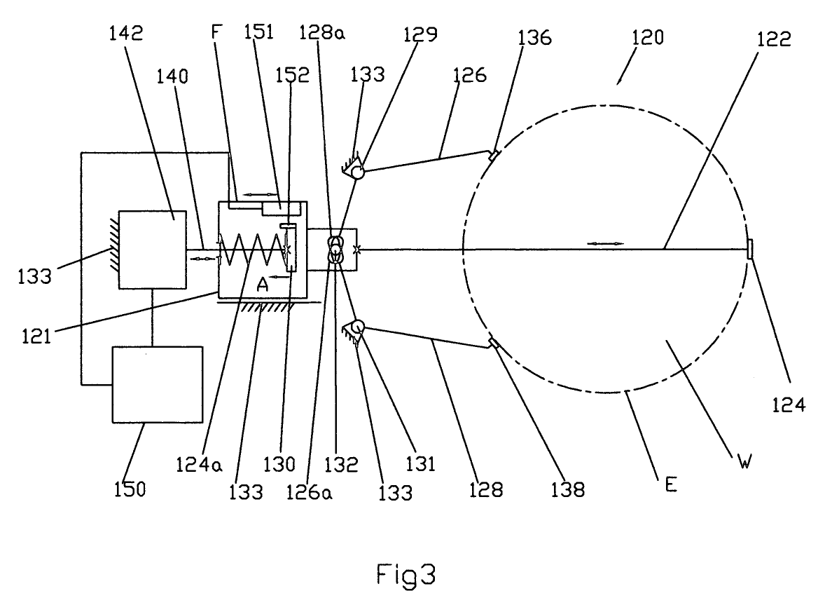

FIG. 2 shows positions of various parts (i.e., the gripping fingers 122, 126, 128, the gripping posts 124, 136, 138, the pusher plate 130, and other associated parts) in an open position of the gripper mechanism, i.e., when the gripping posts 124, 136, 138 are shifted outward from the edge E of the semiconductor wafer W. FIG. 3 shows the same parts in the gripping position, i.e., when the gripping posts 124, 136, 138 grip the semiconductor wafer W with soft touch controlled by the position sensor S via the controller 150. It can be clearly seen from FIG. 3 that in the gripping position of the gripping posts 124, 136, and 138 a space G is formed between the pusher plate 130 and the mating inner end face 123 of the frame F. The space G is formed due to retracted movement of the output shaft 140 of the linear stepper motor 142 together with the pusher plate. 130 which is retracted from the end face 123 of the frame F and compresses the spring 124a. The retraction movement stops when the soft-touch gripping force on the respective posts reaches the value set in the controller 150.

In order to facilitate insertion of the distal finger into narrow slots between the flat objects, such as semiconductor wafers in the storage cassette (not shown), the distal post 124 can be turned as in the aforementioned Holbrooks patent.

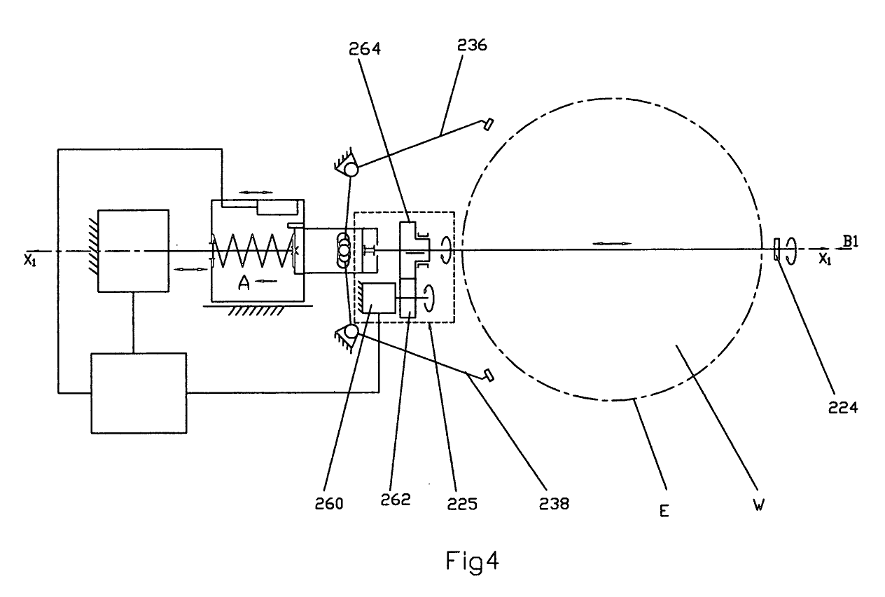

However, in order to improve the non-contamination conditions, as compared to the Holbrooks device, the first finger with the distal post is rotated by less than 75°. FIG. 4 is a schematic view of the gripping mechanism 220 of the invention which, in general, is the same as the mechanism shown in FIGS. 2 and 3, but, in addition, is provided with a mechanism 225 for rotating the first finger 222 (FIG. 4) with the distal gripping post 224 attached thereto.

As shown in FIG. 4, the rotating mechanism 225 comprises a self-contained reducer that consists of a drive motor 260 that supports on its output shaft a gear wheel 262 which is in mesh with a gear wheel 264. The letter has sliding connection with the first gripping finger 222 on splines or on a guide key (not shown) so that the gripping finger 222 rotates together with the gear wheel 264 and at the same time can slide in the axial direction of the longitudinal axis X1-X1. The rotation of the gripping finger 222 and of the gripping post 224 does not interfere with the gripping action described above.

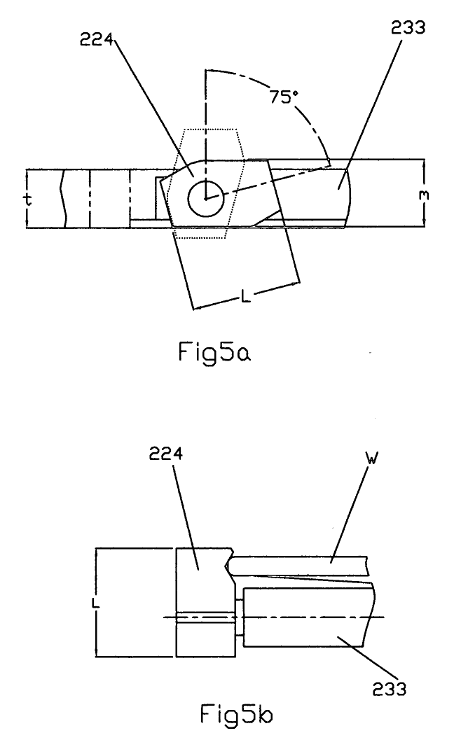

FIG. 5A is a fragmental end view of the distal gripping post arrangement in the direction of arrow C in FIG. 4 with the distal gripping post 224 shown in a hidden position for insertion of the finger post 224 into a narrow space between the adjacent wafers in the storage cassette (not shown in FIG. 5A). In other words, in this position the distal post 224 is arranged substantially in flush with the upper and lower surfaces of the flat gripper body 233. Since the body of the gripper has a certain thickness “t”, the distal post 224 may have such a configuration that allows normal gripping conditions with rotation of the gripping post 224 from the position shown in FIG. 5A by solid lines to the position shown by broke lines by an angle substantially less than 90°. For example, as shown in FIG. 5A, the gripping post 224 can be turned 75°. If necessary, the rotation angle can be less than 75°, e.g., 60°, 65°, 70°. It is recommended that the width “m” of the gripping post 224 be equal to or less than the thickness “t” of the gripper body and the length “L” of the post 224 be less than the space between the adjacent wafers in the storage cassette but greater than the thickness “t” plus the thickness of the wafer W. It is obvious that the smaller is the post rotation angle, the shorter is the movement and the movement time, and therefore the less is contamination caused by friction in sliding pairs. In other words, the design corresponding to the present invention makes it possible to satisfy the contamination prevention requirements to the highest standards of the field.

FIG. 5B is a fragmental side view of the gripping post 224 in the gripping position. The front face of the gripping post 224 has a special profile to accommodate the edge of the wafer W.

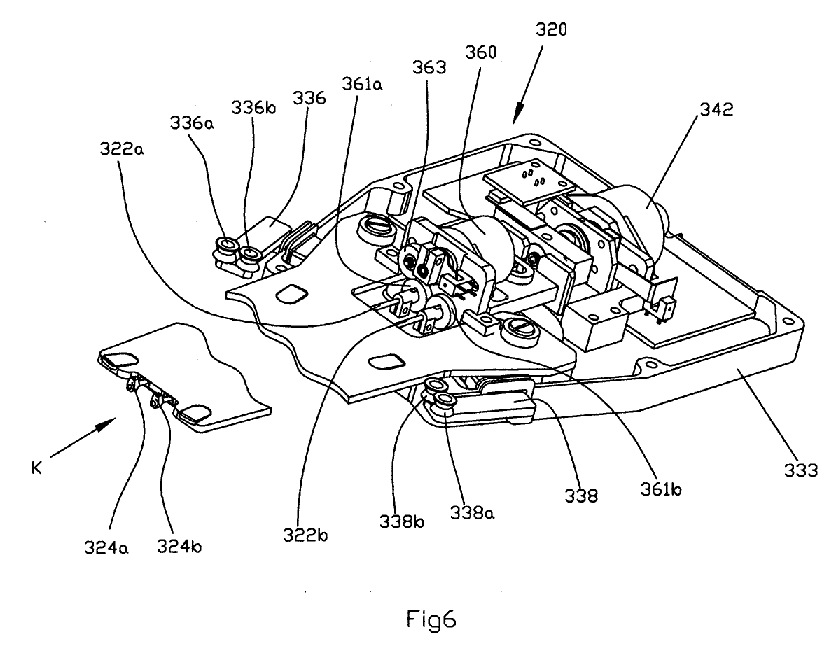

FIG. 6 is a general three-dimensional view of the soft-touch gripping mechanism 320 of the third embodiment shown with the upper cover removed for simplicity of the explanation. In general, this mechanism is the same as the one described in connection with FIG. 4 but with at least two gripping posts on each gripping finger for prevention of dropping of any gripping post into the notch N on the edge of the wafer. The parts and units of the mechanism 320 similar to those of the embodiment of FIG. 4 will be designated by the same reference numerals with addition of 100 and their description will be omitted. For example, the side gripping fingers will be designated 336 and 338, respectively, etc. However, there are two longitudinal gripping fingers 322a and 322b which are driven from a common motor 360 via gear wheels 361, 361a, and 361b. The gear wheel 361 is fixed on the output shaft of the motor 360, while the gear wheels 361a and 361b have a sliding fit with respective longitudinal fingers 322a and 322b and rotate together with them. For preventing engagement with the wafer notch N, the side gripping finger 336 supports at least two gripping posts 336a and 336b. Similarly, the side gripping finger 338 supports at least two gripping posts 338a and 338b.

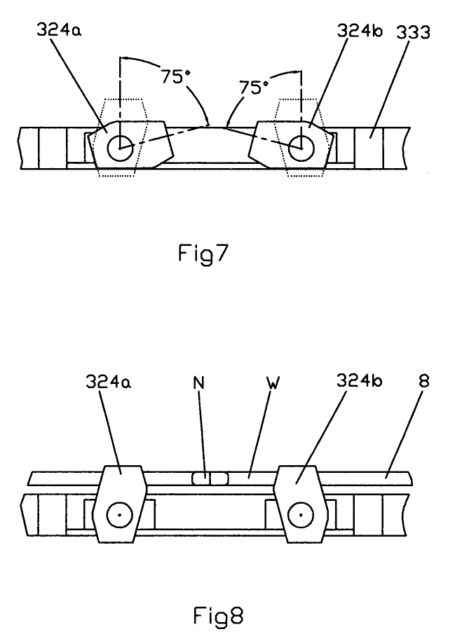

FIG. 7 is a fragmental end view in the direction of arrow K in FIG. 6. This view is similar to the one shown in FIG. 5A but illustrates two distal finger posts 324a and 324b in the hidden position. FIG. 8 is a view similar to FIG. 7 but with the finger posts 324a and 324b in the wafer gripping positions, in which these posts are turned by an angle less than 90° due to engagement of gear wheels 361a and 361b (FIG. 6).

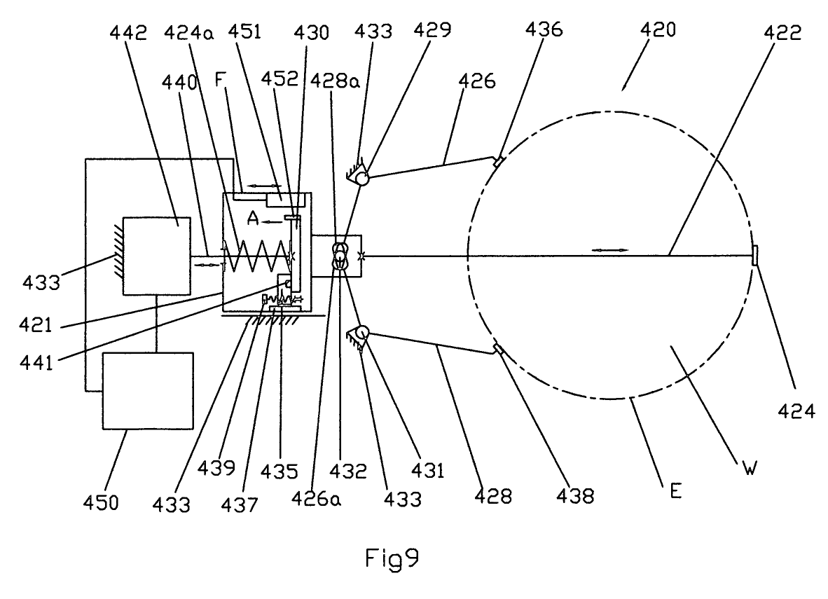

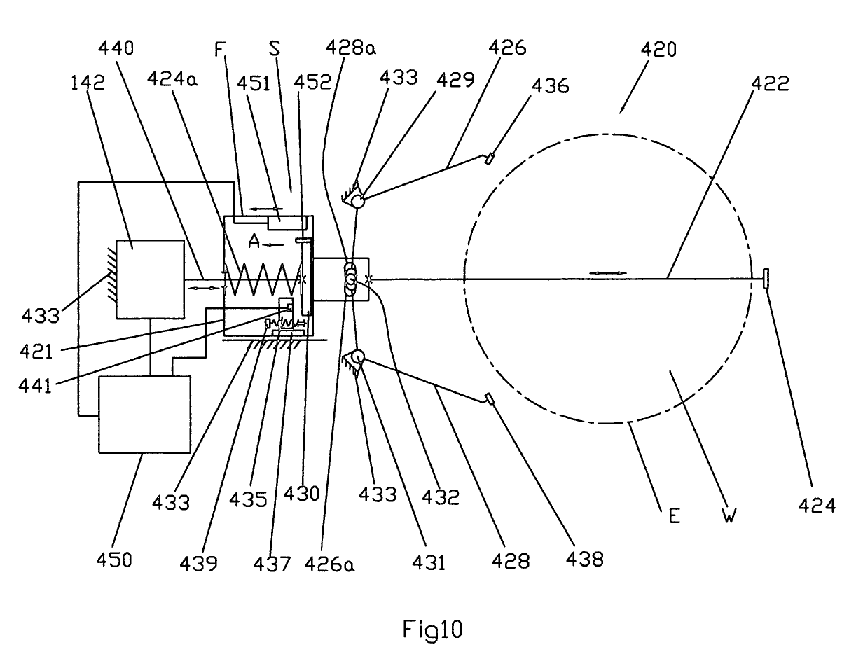

FIGS. 9 and 10 illustrate another embodiment of the invention, wherein FIG. 9 is a view similar to FIG. 3 for embodiment of the invention with a contact sensor attached to a pusher plate stopper, the grippers being shown in a closed position, and wherein FIG. 10 is a view similar to FIG. 2 for embodiment of the invention with a contact sensor attached to a pusher plate stopper, the grippers being shown in an open position.

In general, the apparatus of the embodiment shown in FIGS. 9 and 10 is the same as the one shown in FIGS. 2 and 3 and the parts and units of the embodiment of FIGS. 9 and 10 will be designated by the same reference numerals but with addition of 300 hundred. Thus, the grippers will be designated as 426, 428, the gripping posts will be designated as 424, 436, 438, etc. In this embodiment, in addition to all parts and units used in the previous embodiment, the apparatus of FIGS. 9 and 10 has means for accurate adjustment of the soft-tough gripping force. This is achieved by providing the moveable frame F with a stopper 435 installed on a guide 437 formed on the frame F. Positions of the stopper 435 on the guide 437 can be adjusted, e.g., by means of a screw 439. On its side facing the pusher plate 430, the stopper 435 supports a microswitch 441 that is electrically connected to the controller 450. Interaction of the microswitch 441 with the pusher plate 430 will activate the microswitch 441. The latter will send an appropriate command to the controller 450 which in turn will stop the motor 433.

It is understood that the position of the stopper 435 on the guide 437 will determine degree of final compression of the spring 424a and hence the final soft-tough force with which the semiconductor wafer is gripped by the gripping posts 424, 436, and 438. The microswitch may comprise a limit switch, a contact sensor such as a Hall sensor, etc.

Thus, it has been shown that the invention provides an improved soft-touch gripping mechanism for loading/unloading flat precision objects under strict clean-room requirements that simultaneously satisfies the requirements of simplicity, reliability of soft touch and non-contamination of the objects during handling.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the gripping force can be controlled by using an “open loop” system (programmed stepper motor counts) or a “closed loop” system motor control (linear encoder, Hall sensor, etc.). The spring may be of a compression type or of an expansion type. The distal posts may have configurations different from those shown in the drawings, provided that these configurations are selected based on the condition for minimization of the rotation angle of the post. Each finger may support gripping fingers in an amount of more than two. The posts themselves may comprise rotating rollers or stationary pins.

1. A precision soft-touch gripping mechanism for flat objects having a peripheral edge, said mechanism comprising:
a flat gripper body having an upper surface, a lower surface and
attachable to an external manipulation means;
at least one longitudinal gripping finger in the form of an elongated member having a distal end and a proximal end, said distal end supporting at least one distal gripping post;
a first side gripping finger comprising a lever of the second order pivotally installed on said gripper body and having a first arm and a second arm, said first arm supporting at least one second side gripping post, and said second arm having a first guide slot;
a second side gripping finger comprising a lever of the second order pivotally installed on said gripper body and having a third arm and a forth arm, said third arm supporting at least one third side gripping post, and said second arm having a second guide slot;
a pin that is rigidly attached to said proximal end of said at least one longitudinal gripping finger and is guided in said first guide slot and in said second guide slot simultaneously;
a moveable frame that rigidly supports said pin and is moveable in the direction of said at least one longitudinal gripping finger, said frame having a first end face nearest to said pin and a second end face opposite to said first end face;
linear drive means having an output shaft that supports pushing member;
a flexible member between said pushing member and said second end face of said frame; and
gripping force control means common for said at least one longitudinal gripping finger, said first side gripping finger, and said second side gripping finger for controlling a final soft-touch gripping force applied from said at least one distal gripping post, said second side gripping post, and said third side gripping force to said periphery edges of said flat objects via said flexible member.

2. The precision soft-touch gripping mechanism of claim 1, further provided with rotary drive means for rotating said at least one longitudinal gripping finger with said at least one distal gripping post by an angle less than 90° between a position, in which the configuration of said at least one longitudinal gripping finger is in flush with said gripper body and substantially do not project beyond the boundaries of said upper surface and said lower surface of said gripper body and a position in which said at least one longitudinal gripping finger projects above said upper surface.

3. The precision soft-touch gripping mechanism of claim 1, wherein said angle less than 90° is selected from 60°, 65°, 70°, 75°, 80°, 85°, and 88°.

4. The precision soft-touch gripping mechanism of claim 1, gripping force control means comprises: controller means and a position sensor, said position sensor comprising flag means attached to said pushing member and a measurement means attached to said moveable frame and sensitive to a position of said flag means, said measurement means and said linear drive means being electrically connected to said controller means.

5. The precision soft-touch gripping mechanism of claim 1, wherein said flag means is a magnetic member and said measurement means is a Hall sensor chip that responds to the position of said magnetic flag and generates a voltage signal which is sent to said controller means and which is proportional to said position of said magnetic flag, said controller means being set to a preset value of said voltage signal corresponding to said final soft-touch gripping force and sends a signal for stopping said linear drive means when said voltage signal becomes equal to said preset value.

6. The precision soft-touch gripping mechanism of claim 5, wherein said flag means is a magnetic member and said measurement means is a Hall sensor chip that responds to the position of said magnetic flag and generates a voltage signal which is sent to said controller means and which is proportional to said position of said magnetic flag, said controller means being set to a preset value of said voltage signal corresponding to said final soft-touch gripping force and sends a signal for stopping said linear drive means when said voltage signal becomes equal to said preset value.

7. The precision soft-touch gripping mechanism of claim 1, wherein said flexible member is a helical spring.

8. The precision soft-touch gripping mechanism of claim 3, wherein said flexible member is a helical spring.

9. The precision soft-touch gripping mechanism of claim 6, wherein said flexible member is a helical spring.

10. The precision soft-touch gripping mechanism of claim 5, wherein said flexible member is a helical spring.

11. The precision soft-touch gripping mechanism of claim 2, wherein said rotary drive means comprises a rotary drive motor with a driving member and driven member engaged with said driving member and fitted onto said longitudinal gripping finger with means for rotation together with said driven member and with possibility of relative movement between said longitudinal gripping finger and said driven means in said direction of said at least one longitudinal gripping finger.

12. The precision soft-touch gripping mechanism of claim 8, wherein said rotary drive means comprises a rotary drive motor with a driving member and driven member engaged with said driving member and fitted onto said longitudinal gripping finger with means for rotation together with said driven member and with possibility of relative movement between said longitudinal gripping finger and said driven means in said direction of said at least one longitudinal gripping finger.

13. The precision soft-touch gripping mechanism of claim 9, wherein said rotary drive means comprises a rotary drive motor with a driving member and driven member engaged with said driving member and fitted onto said longitudinal gripping finger with means for rotation together with said driven member and with possibility of relative movement between said at least one longitudinal gripping finger and said driven means in said direction of said at least one longitudinal gripping finger.

14. The precision soft-touch gripping mechanism of claim 2, further comprising an additional longitudinal gripping finger arranged parallel to said at least one longitudinal gripping finger and supporting a second distal gripping post, said driven member being engaged with a second driven member which is fitted on said additional longitudinal gripping finger with possibility of relative movement between said additional longitudinal gripping finger and said second driven member in said direction of said additional longitudinal gripping finger, said first side gripping finger having a first additional side gripping post located near said at least one second side gripping post, and said second side gripping finger having a second additional side gripping post located near said at least one third side gripping post.

15. The precision soft-touch gripping mechanism of claim 8, further comprising an additional longitudinal gripping finger arranged parallel to said at least one longitudinal gripping finger and supporting a second distal gripping post, said driven member being engaged with a second driven member which is fitted on said additional longitudinal gripping finger with possibility of relative movement between said additional longitudinal gripping finger and said second driven member in said direction of said additional longitudinal gripping finger, said first side gripping finger having a first additional side gripping post located near said at least one second side gripping post, and said second side gripping finger having a second additional side gripping post located near said at least one third side gripping post.

16. The precision soft-touch gripping mechanism of claim 9, further comprising an additional longitudinal gripping finger arranged parallel to said at least one longitudinal gripping finger and supporting a second distal gripping post, said driven member being engaged with a second driven member which is fitted on said additional longitudinal gripping finger with possibility of relative movement between said additional longitudinal gripping finger and said second driven member in said direction of said additional longitudinal gripping finger, said first side gripping finger having a first additional side gripping post located near said at least one second side gripping post, and said second side gripping finger having a second additional side gripping post located near said at least one third side gripping post.

17. The precision soft-touch gripping mechanism of claim 1, further provided with a stopper attached to said moveable frame and supporting a switching member electrically connected to said gripping force control means for controlling operation of said linear drive means, said switching means being capable of engaging said pushing member during movement of said pushing member.

18. The precision soft-touch gripping mechanism of claim 17, further provided with means for adjusting position of said stopper with respect to said moveable frame.

19. The precision soft-touch gripping mechanism of claim 2, further provided with a stopper attached to said moveable frame and supporting a switching member electrically connected to said gripping force control means for controlling operation of said linear drive means, said switching means being capable of engaging said pushing member during movement of said pushing member.

20. The precision soft-touch gripping mechanism of claim 19, further provided with means for adjusting position of said stopper with respect to said moveable frame.

21. The precision soft-touch gripping mechanism of claim 6, further provided with a stopper attached to said moveable frame and supporting a switching member electrically connected to said gripping force control means for controlling operation of said linear drive means, said switching means being capable of engaging said pushing member during movement of said pushing member.

22. The precision soft-touch gripping mechanism of claim 21, further provided with means for adjusting position of said stopper with respect to said moveable frame.

23. The precision soft-touch gripping mechanism of claim 14, further provided with a stopper attached to said moveable frame and supporting a switching member electrically connected to said gripping force control means for controlling operation of said linear drive means, said switching means being capable of engaging said pushing member during movement of said pushing member.

24. The precision soft-touch gripping mechanism of claim 23, further provided with means for adjusting position of said stopper with respect to said moveable frame.
